(19) United States
(12) Patent Application Publication
(10) Pub. No.: US 2021/0334868 A1
(43) Pub. Date: Oct. 28, 2021

(54) USING SCENARIOS TO MITIGATE SELLER RISK TO ENTER ONLINE PLATFORMS

(71) Applicant: Intuit Inc., Mountain View, CA (US)

(72) Inventors: Yair Horesh, Kfar Sava (IL); Yehezkel Shraga Resheff, Hasharon (IL); Shlomi Medalion, Lod (IL); Adi Shalev, Herzliya (IL); Miriam Hanna Manevitz, Hod Hasharon (IL); Sigalit Bechler, Hod Hasharon (IL); Elik Sror, Hod Hasharon (IL)

(73) Assignee: Intuit Inc., Mountain View, CA (US)

(21) Appl. No.: 16/859,604

(22) Filed: Apr. 27, 2020

(51) Int. Cl. G06Q 30/06; G06K 9/62

(52) U.S. Cl. CPC G06Q 30/0617; G06K 9/6215; G06Q 30/0629

(57) ABSTRACT

A method may include generating, using a flow proportionalized graph, scores for platform sellers of an online platform. The flow proportionalized graph may include nodes corresponding to the platform sellers and buyers, and edges each connecting a buyer node corresponding to a buyer initiating a monetary transfer and a platform seller node corresponding to a platform seller receiving the monetary transfer. Each edge may have a weight that is a proportion of total monetary transfers by the buyer received by the platform seller. The method may further include matching, using the scores and a seller similarity metric, a non-platform seller with a platform seller, receiving a scenario for the platform seller to sell an item of the non-platform seller via the online platform, and generating a prediction regarding an outcome of the scenario by applying a model to scenarios.

### BACKGROUND

Small business sellers considering entry to an online platform face risks due to significant operational costs not covered by profits. Even when the likelihood of success exceeds the likelihood of failure, the potential for loss often inhibits a small business seller from taking the risk. Thus, there is a need for a mechanism to mitigate the risk incurred by a seller when entering an online platform.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a method including generating, using a flow proportionalized graph, scores for platform sellers of an online platform. The flow proportionalized graph includes nodes corresponding to the platform sellers and buyers, and edges each connecting a buyer node corresponding to a buyer initiating a monetary transfer and a platform seller node corresponding to a platform seller receiving the monetary transfer. Each edge has a weight that is a proportion of total monetary transfers by the buyer received by the platform seller. Each node has a score based on scores of buyer nodes connected to the node by one of the edges. The method further includes matching, using the scores and a seller similarity metric, a non-platform seller with a platform seller, receiving a scenario for the platform seller to sell an item of the non-platform seller via the online platform, and generating a prediction regarding an outcome of the scenario by applying a model to scenarios.

In general, in one aspect, one or more embodiments relate to a system including a computer processor and a repository configured to store a flow proportionalized graph including nodes corresponding to platform sellers and buyers of an online platform, and edges each connecting a buyer node corresponding to a buyer initiating a monetary transfer and a platform seller node corresponding to a platform seller receiving the monetary transfer. Each edge has a weight that is a proportion of total monetary transfers by the buyer received by the platform seller. Each node has a score based on scores of buyer nodes connected to the node by one of the edges. The system further includes a scenario engine executing on the computer processor and configured to generate, using the flow proportionalized graph, scores for the platform sellers, match, using the scores and a seller similarity metric, a non-platform seller with a platform seller, receive a scenario for the platform seller to sell an item of the non-platform seller via the online platform, and generate a prediction regarding an outcome of the scenario by applying a model to scenarios.

In general, in one aspect, one or more embodiments relate to a method including obtaining, via a graphical user interface (GUI) and from a non-platform seller, a request for a platform seller of an online platform to sell an item of the non-platform seller, and sending the request to a scenario engine. The scenario engine generates, using a flow proportionalized graph, scores for platform sellers of the online platform. The flow proportionalized graph includes nodes corresponding to the platform sellers and buyers, and edges each connecting a buyer node corresponding to a buyer initiating a monetary transfer and a platform seller node corresponding to a platform seller receiving the monetary transfer. Each edge has a weight that is a proportion of total monetary transfers by the buyer received by the platform seller. Each node has a score based on scores of buyer nodes connected to the node by one of the edges. The scenario engine further matches, using the scores and a seller similarity metric, a non-platform seller with a platform seller, receives a scenario for the platform seller to sell an item of the non-platform seller via the online platform, and generates a prediction regarding an outcome of the scenario by applying a model to scenarios. The method further includes receiving, via the GUI, the prediction regarding the outcome of the scenario, and displaying, in an element within the GUI generated by a computer processor, the prediction regarding the outcome of the scenario.

Other aspects of the invention will be apparent from the following description and the appended claims.

### BRIEF DESCRIPTION OF DRAWINGS

FIG. 1A and FIG. 1B show a system in accordance with one or more embodiments of the invention.

FIG. 2 and FIG. 3 show flowcharts in accordance with one or more embodiments of the invention.

FIG. 4 shows an example in accordance with one or more embodiments of the invention.

FIG. 5A and FIG. 5B show computing systems in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

A small business owner may seek a low risk entry to begin selling items on a new online platform. For example, risks associated with entering the online platform may include costs to develop a website, fees charged by the online platform, operational costs, etc. The small business owner, called a non-platform seller, may be matched, using machine learning, with another small business owner, called a platform seller, who already sells items via the online platform. The matching may be based on the similarity of the platform seller to the non-platform seller, as well as the popularity of the platform seller on the online platform. A scenario may be defined where the platform seller sells items of the non-platform seller. For example, the scenario may provide the platform seller with exclusive rights to sell the items of the non-platform seller on the online platform for a predefined time interval and/or quantity. A predicted outcome may be generated for the scenario using machine learning. For example, the predicted outcome may be a predicted profit that benefits both the platform seller and the non-platform seller.

In general, embodiments of the invention are directed to predicting an outcome of a scenario on the platform. In one or more embodiments, scores for platform sellers of an online platform are generated using a flow proportionalized graph that scores the platform sellers based on flows of money transferred between buyers and the platform sellers. A flow proportionalized graph is a graph where each edge from a first node to a second node is weighted by the proportion of the flow from the first node to the second node relative to the total flow emanating from the first node via any edge. A non-platform seller may be matched with a platform seller using the scores and a seller similarity metric. The seller similarity metric may be calculated by analyzing textual descriptions of items sold by the non-platform seller and by the platform sellers. For example, the seller similarity metric may be based on the cosine similarity between vector embedding s derived from textual descriptions of items sold by the non-platform seller and the platform seller. A scenario for the platform seller to sell an item of the non-platform seller via the online platform is received. The scenario may be based on a selection, by the non-platform seller, of the platform seller from a list of platform sellers. The scenario may be thought of as an experiment that mitigates the risk incurred by the non-platform seller to sell the item via the online platform. A prediction regarding the outcome of the scenario may be generated by applying a model (e.g., a regression model) to scenarios where the platform seller sold items of other non-platform sellers. For example, the outcome may be a predicted profit. The model may further be based on the volume of sales of items similar to the item included in the scenario.

Armed with a favorable predicted outcome of a scenario that matched a platform seller with the non-platform seller, the risk for the non-platform seller to begin selling items on the online platform may be mitigated, in part due to leveraging the existing capabilities of the platform seller on the online platform.

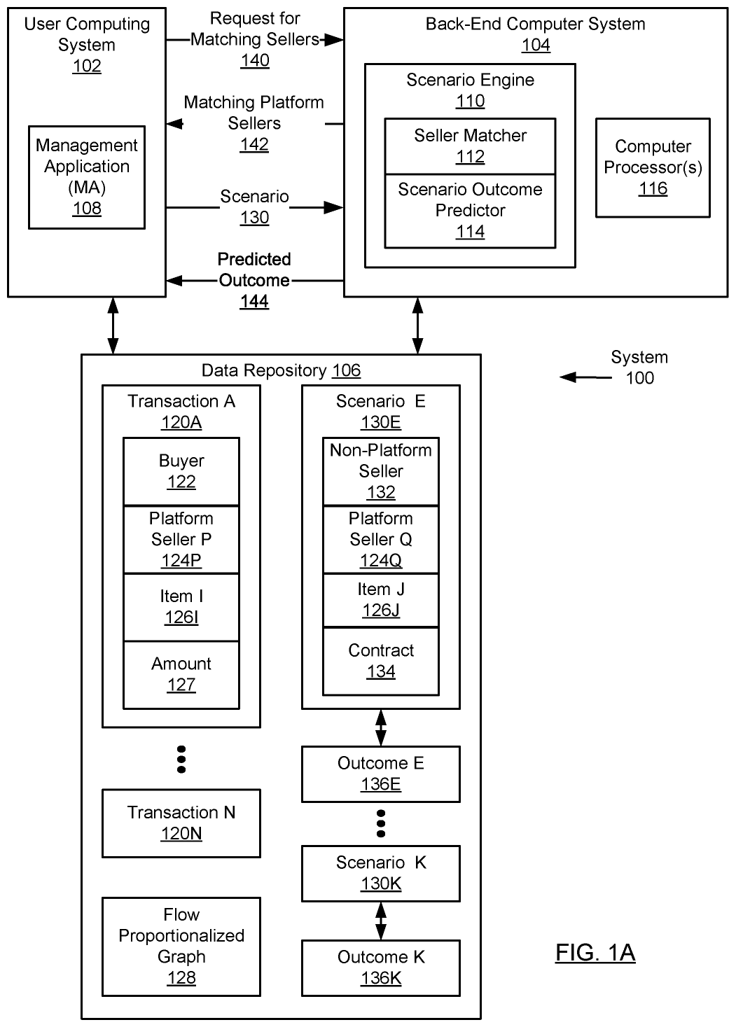

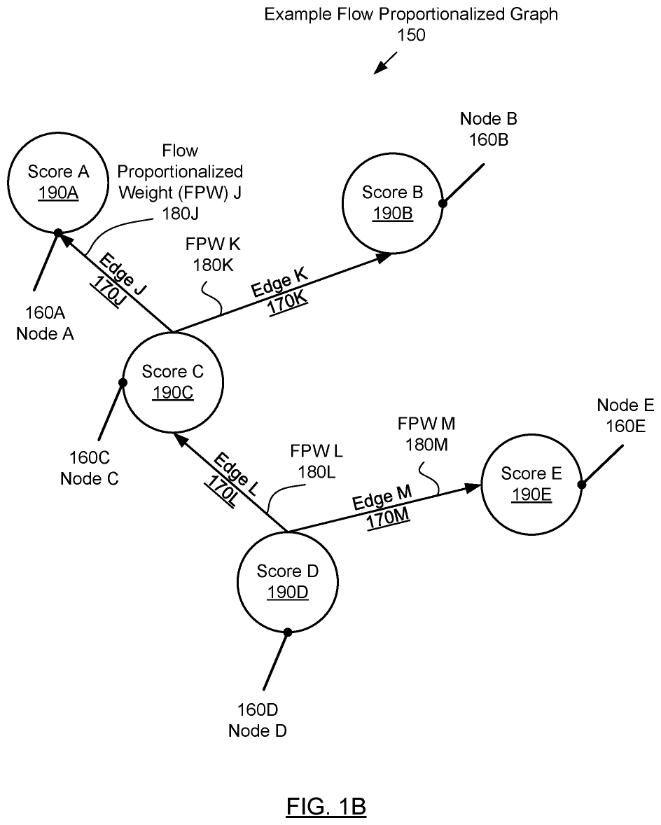

FIG. 1A shows a flow diagram of a system (100) in accordance with one or more embodiments. As shown in FIG. 1A, the system (100) includes multiple components such as the user computing system (102), a back-end computing system (104), and a data repository (106). Each of these components is described below.

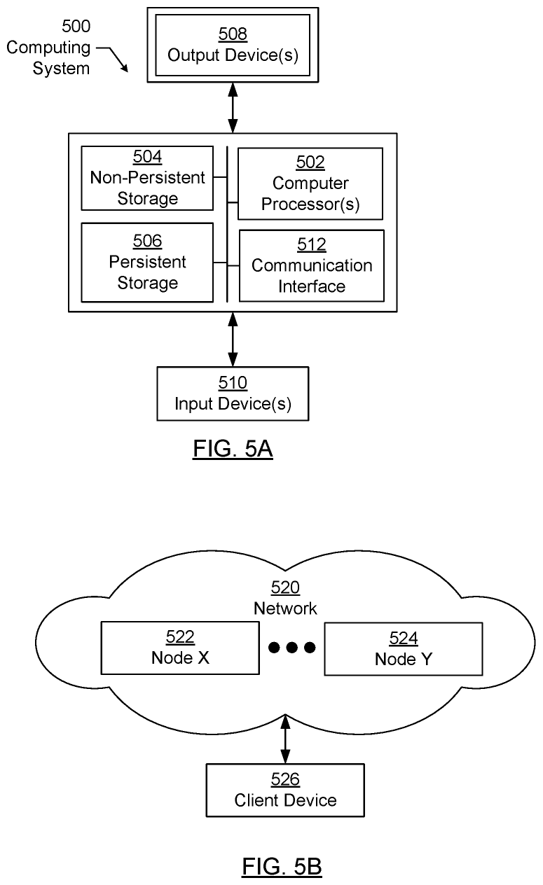

In one or more embodiments, the user computing system (102) provides, to a user, a variety of computing functionality. For example, the computing functionality may include word processing, multimedia processing, financial management, business management, social network connectivity, network management, and/or various other functions that a computing device performs for a user. The user may be a company employee that acts as a sender, a potential sender, or a requestor of services performed by a company (e.g., a client, a customer, etc.) of the user computing system. The user computing system (102) may be a mobile device (e.g., phone, tablet, digital assistant, laptop, etc.) or any other computing device (e.g., desktop, terminal, workstation, etc.) with a computer processor (not shown) and memory (not shown) capable of running computer software. The user computer system (102) may take the form of the computing system (500) shown in FIG. 5A connected to a network (520) as shown in FIG. 5B.

The user computing system (102) includes a management application (MA) (108) in accordance with one or more embodiments. The MA (108), in accordance with one or more embodiments, is a software application written in any programming language that includes executable instructions stored in some sort of memory. The instructions, when executed by one or more processors, enable a device to perform the functions described in accordance with one or more embodiments. In one or more embodiments, the MA (108) is capable of assisting a user with the user's finances or business needs. For example, the MA (108) may be any type of financially-based application such as a tax program, a personal budgeting program, a small business financial program, or any other type of program that assists with finances.

The MA (108) may include a user interface (UI) (not shown) for receiving input from a user and transmitting output to the user. For example, the UI may be a graphical user interface or other user interface. The UI may be rendered and displayed within a local desktop software application or the UI may be generated by a remote web server and transmitted to a user's web browser executing locally on a desktop or mobile device. For example, the UI may be an interface of a software application providing the functionality to the user (e.g., a local gaming application, a word processing application, a financial management application, network management application, business management application etc.). In such a scenario, the help menu, popup window, frame, or other portion of the UI may connect to the MA (108) and present output.

Continuing with FIG. 1A, the data repository (106) is any type of storage unit and/or device (e.g., a file system, database, collection of tables, or any other storage mechanism) for storing data. Further, the data repository (106) may include multiple different storage units and/or devices. The multiple different storage units and/or devices may or may not be of the same type or located at the same physical site. The data repository (106) may be accessed online via a cloud service (e.g., Amazon Web Services, Egnyte, Azure, etc.).

In one or more embodiments, the data repository (106) includes functionality to store transactions (120A, 120N), a flow proportionalized graph (128), and scenarios (130E, 130K). A transaction (120A) may be a record of an event involving two entities: a buyer (122) and a platform seller (124P) of an online platform. For example, the online platform may be an electronic retail (e.g., e-commerce) platform such as Etsy, Amazon, etc. Both the buyer (122) and/or the platform seller (124P) may be individuals or groups (e.g., businesses). In addition, a platform seller (124P) in one transaction may be a buyer (122) in another transaction, and vice versa. The transaction (120A) may record an acquisition (e.g., a purchase) of an item (1261) by the buyer (122) from the platform seller (124P). The item (1261) may be acquired by the buyer (122) from the platform seller (124P) in exchange for an amount (127) (e.g., of money) transferred from the buyer (122) to the platform seller (124). The buyer (122) and/or the platform seller (124P) may be represented by identifiers (e.g., unique identifiers). The item (1261) may be a product provided by the platform seller (124P). Alternatively, the item (1261) may be a service provided by the platform seller (124P). The transaction (120A) may include additional information, such as a receipt, invoice, shipping information, etc.

A flow proportionalized graph (128) is a graph where the weight of each edge is flow proportionalized. That is, each edge from a first node to a second node is weighted by the proportion of the flow from the first node to the second node relative to the total flow emanating from the first node via any edge. FIG. 1B shows an example flow proportionalized graph (150) that includes nodes (160A, 160B, 160C, 160D, 160E) and edges (170J, 170K, 170L, 170M). The edges (170J, 170K, 170L, 170M) are directed edges. The edges (170J, 170K, 170L, 170M) correspond to flow proportionalized weights (FPWs) (180J, 180K, 180L, 180M). In one or more embodiments, the sum of the FPWs on the edges emanating from each node a constant (e.g., 1). For example, the sum of FPW J (180J) and FPW K (180K) equals 1 because node C (160C) is the source of exactly two edges, edge J (170J) and edge K (170K). FPW J (180J) represents the proportion of the flow from node C (160C) to node A (160A) relative to the total flow emanating from node C (160C) via any edge, and FPW K (180K) represents the proportion of the flow from node C (160C) to node B (160B) relative to the total flow emanating from node C (160C) via any edge. Continuing this example, the flow from node C (160C) to node A (160A) may be a money flow of $20 and the flow from node C (160C) to node B (160B) may be a money flow of $40. Then FPW J (180J) is ⅓ because the flow from node C (160C) to node A (160A) is ⅓ of the total flow of $60 emanating from node C (160C) via directed edges. Similarly, FPW K (180K) is ⅔ because the flow from node C (160C) to node B (160B) is ⅔ of the total flow of $60 emanating from node C (160C) via directed edges.

FIG. 1B shows that the nodes (160A, 160B, 160C, 160D, 160E) correspond to scores (190A, 190B, 190C, 190D, 190E). The score for a node N may be calculated iteratively using the scores of nodes connected to node N via edges flowing to (i.e., terminating on) node N, as described in Step 202 below. Returning to FIG. 1A, in one or more embodiments, the nodes in the flow proportionalized graph (128) correspond to buyers and/or platform sellers of the online platform. The score for a node corresponding to a platform seller (124P) may be used as a measure of the brand strength of the platform seller (124P) on the online platform.

In one or more embodiments, a scenario (130E) is an interaction between a non-platform seller (132) and a platform seller (124Q) where the platform seller (124Q) sells an item (126J) of the non-platform seller (132) via the online platform. The scenario (130E) may be thought of as an experiment that mitigates the risk incurred by the non-platform seller (132) to sell the item (126J) via the online platform. For example, such risks may include infrastructure costs, such as developing and/or maintaining a website accessible via the online platform, in addition to fees charged by the online platform. The scenario (130E) may include a contract (134) that specifies terms governing the interaction between the non-platform seller (132) and the platform seller (124Q). For example, the contract (134) may specify the relative compensation of the non-platform seller (132) and the platform seller (124Q) and/or the relative liabilities (e.g., for inventory-related expenses) of the non-platform seller (132) and the platform seller (124Q). The contract (134) may further specify one or more of the following: quantity and price of the item (126J) to be offered for sale by the platform seller (124Q), a time interval for the scenario (130E), a sales price and/or discount for the item (126J)m, etc.

The scenarios (130E, 130K) correspond to outcomes (136E, 136K). Each outcome (136E) describes a result of the corresponding scenario (130E). The outcome (136E) may be a numerical attribute. For example, the outcome (136E) may be a profit resulting from a subset of the transactions (120A, 120N) corresponding to sales of the item (126J) by the platform seller (124Q) during the time interval of the scenario (130E). Continuing this example, the profit may be based on expenses incurred and revenue generated as a result of the sales of the item (126J) during the time interval of the scenario (130E).

The MA (108) includes functionality to send a request for matching sellers (140) to the scenario engine (110). The request for matching sellers (140) may specify an online platform for which platform sellers matching a non-platform seller (132) are requested. The MA (108) includes functionality to send a scenario (130) to the scenario engine (110). The scenario (130) may include a specific platform seller (124Q).

The back-end computer system (104) is communicatively connected to the user computing system (102) such as through one or more networks. The back-end computer system (104) includes a scenario engine (110) and computer processor(s) (116). The scenario engine (110) includes a seller matcher (112) and a scenario outcome predictor (114). The seller matcher (112) includes functionality to send matching platform sellers (142) (i.e., platform sellers that match the non-platform seller (132)) to the MA (108).

The scenario outcome predictor (114) includes functionality to generate a predicted outcome (144) for the scenario (130). The scenario outcome predictor (114) includes functionality to send the predicted outcome (144) to the MA (108). For example, the scenario outcome predictor (114) may generate the predicted outcome (144) by applying a regression model to scenarios (130E, 130K) in which the platform seller (124Q) of the scenario (130) sold items on behalf of other non-platform sellers. The regression model may be a gradient boosted tree for regression (e.g., XGBoost, available at https://github.com/dmlc/xgboost). In one or more embodiments, the regression model is trained using scenarios (130E, 130K) corresponding to the online platform. The scenario outcome predictor (114) includes functionality to send the predicted outcome (144) to the MA (108).

The regression model may further use transactions (120A, 120N) including items similar to the item included in the scenario (130). For example, the regression model may use the volume of sales of items similar to the item included in the scenario (130) when generating the prediction. Still continuing this example, the similar items may be identified using a similarity metric based on textual descriptions of items, as explained in Step 204. The regression model may use additional attributes of the scenario (130), such as: the amount of one-time and/or recurring payments required by the online platform, refund ratio, etc.

In one or more embodiments, the computer processor(s) (116) takes the form of the computer processor(s) (502) described with respect to FIG. 5A and the accompanying description below.

While FIG. 1A and FIG. 1B show a configuration of components, other configurations may be used without departing from the scope of the invention. For example, various components may be combined to create a single component. As another example, the functionality performed by a single component may be performed by two or more components.

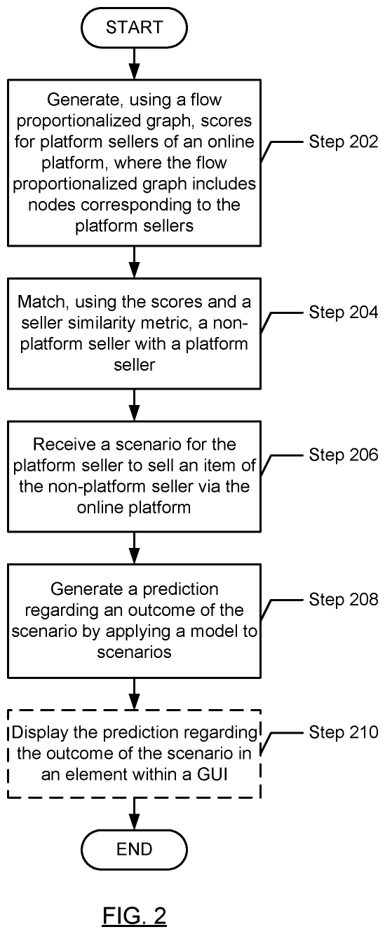

FIG. 2 shows a flowchart in accordance with one or more embodiments of the invention. The flowchart depicts a process for predicting an outcome of a scenario. One or more of the steps in FIG. 2 may be performed by the components (e.g., the scenario engine (106) of the back-end computing system (104) and the management application (MA) (108) of the user computing system (102)), discussed above in reference to FIG. 1A. In one or more embodiments of the invention, one or more of the steps shown in FIG. 2 may be omitted, repeated, and/or performed in parallel, or in a different order than the order shown in FIG. 2. Accordingly, the scope of the invention should not be considered limited to the specific arrangement of steps shown in FIG. 2.

Initially, in Step 202, scores for platform sellers of an online platform are generated using a flow proportionalized graph. The seller matcher of the scenario engine may construct the flow proportionalized graph using the transactions of the online platform occurring over a specific time interval as follows:

1) add, to the flow proportionalized graph, nodes corresponding to the platform sellers and buyers of the online platform;

2) add an edge between a buyer and a platform seller with a flow proportionalized weight (FPW) that represents the proportion of total monetary amounts transferred by the buyer that are received by the platform seller; and

3) calculate, iteratively, a score for each node K using the scores of buyer nodes connected to node K by an edge. For example, initially each node may have the same score. Then, at each iteration, the score of each buyer node may be distributed (e.g., equally) to the platform seller nodes connected by an edge to the buyer node. Continuing this example, the score for a platform seller node K may be calculated using the following formula:

Score(platform seller node_{K})=sum for all the buyer nodes of platform seller node_{K}: score(buyer node)/#platform seller nodes(buyer node)

That is, the score for a platform seller node K is the sum of the scores of the buyer nodes of platform seller node K, where each buyer node score is divided by the number of platform seller nodes connected to (i.e., receiving a money flow from) the buyer node.

In Step 204, a non-platform seller is matched with a platform seller using the scores and a seller similarity metric. The seller matcher may perform the matching in response to receiving a request for matching sellers from the management application (MA). The seller matcher may calculate the seller similarity metric by analyzing textual descriptions of items sold by the non-platform seller and textual descriptions of items sold by platform sellers. The textual descriptions of items may be extracted from one or more of the following data sources: invoices of the non-platform seller and the platform seller, reviews of the non-platform seller and the platform seller, websites of the non-platform seller and the platform seller, and/or any data source where textual descriptions of items sold by the non-platform seller and the platform seller are available.

In one or more embodiments, the seller matcher embeds the textual descriptions as vectors that represent the textual descriptions as points in a multi-dimensional semantic space. The value assigned to each dimension of a vector embedding (e.g., a word2vec embedding) may be based on the co-occurrence of a textual description with one or more other textual descriptions in a set of training data. The seller matcher may calculate vector distances between the vector embeddings as a measure of contextual similarity between the textual descriptions. For example, the seller similarity metric may be based on the cosine similarity between vector embeddings derived from textual descriptions of items sold by the non-platform seller and the platform seller.

The seller matcher may generate matches between the non-platform seller and one or more platform sellers using: 1) the scores of the nodes corresponding to the platform sellers in the flow proportionalized graph, and 2) the values of the seller similarity metric between the non-platform seller and the platform sellers. The seller matcher may generate a list of platform sellers that satisfy matching criteria. The seller matcher may send, to the management application, the list of platform sellers satisfying the matching criteria. For example, one matching criterion may be that the score of the node corresponding to a platform seller exceed a threshold score (e.g., to ensure that the platform seller has a sufficient amount of “brand presence” on the online platform). Another matching criterion may be that the value of the seller similarity metric between the non-platform seller and the platform seller exceed a threshold value. The seller matcher may rank the list of platform sellers that satisfy the matching criteria according to a policy. For example, the policy may combine, using a weighted average, the score of the node corresponding to the platform seller and the value of the seller similarity metric between the non-platform seller and the platform seller.

In Step 206, a scenario for the platform seller to sell an item of the non-platform seller via the online platform is received. In one or more embodiments, the scenario engine receives the scenario based on a selection of the platform seller from the list of platform sellers generated by the seller matcher in Step 204 above. For example, the non-platform seller may select, via a GUI of the management application, the platform seller from the list of platform sellers. Continuing this example, the non-platform seller may indicate, via the GUI of the management application, the item to be used in the scenario. The scenario engine may receive the selected platform seller and/or the item to be used in the scenario from the management application.

In one or more embodiments, the scenario engine specifies a contract that includes terms governing the interaction between the non-platform seller and the platform seller under the scenario. For example, the scenario engine may specify the contract after both the non-platform seller and the platform seller agree to the scenario.

In Step 208, a prediction regarding an outcome of the scenario is generated by applying a model to scenarios. In one or more embodiments, the scenario outcome predictor generates the predicted outcome (e.g., predicted profit) by applying a regression model to the outcomes of previous scenarios where the platform seller sold an item of a non-platform seller. For example, the scenario outcome predictor may query a repository for previous scenarios and corresponding outcomes where the platform seller sold an item of a non-platform seller. The prediction may further be based on the volume of sales (e.g., on the online platform) of items similar to the item included in the scenario.

The scenario outcome predictor may use the previous outcomes of the platform seller to propose the relative compensation and/or liability of the non-platform seller and the platform seller under the scenario. For example, if the previous outcomes of the platform seller were highly profitable, then the scenario outcome predictor may propose a more favorable rate of compensation for the platform seller than if the previous outcomes of the platform seller were not profitable, or if the platform seller had no previous outcomes. In addition, the relative compensation and/or liability of the non-platform seller and the platform seller may be based on the score of the platform seller (e.g., a platform seller with a higher score may receive a higher level of compensation).

In one or more embodiments, the management application may offer a loan (e.g., to be included in the contract) to the non-platform seller and/or the platform seller based on the predicted outcome. For example, the management application may offer the loan when the predicted outcome is a level of profitability exceeding a threshold level of profitability. Continuing this example, the management application may further base the loan on knowledge of the financial status of the non-platform seller and/or the platform seller due to the use of the management application by the non-platform seller and/or the platform seller.

Once the scenario is activated, and the platform seller begins selling the item of the non-platform seller on the online platform, the scenario engine may generate one or more reports on the status of the scenario. For example, the reports may include partial outcomes based on expenses incurred and revenue generated under the scenario. Continuing this example, the expenses incurred and revenue generated may be based on transactions of the online platform accessible to the scenario engine and/or transactions corresponding to the platform seller and the non-platform accessible to the management. The scenario engine may store the reports in the data repository.

In Step 210, the prediction regarding the outcome of the scenario is displayed via an element within a graphical user interface (GUI). In one or more embodiments, the element (e.g., a widget) is generated by a computer processor and rendered within the GUI. In one or more embodiments, the GUI displays attributes of the scenario. The GUI may permit a user (e.g., the non-platform seller) to modify one or more of the attributes of the scenario and apply the model to the modified scenario to generate a modified prediction. For example, the attributes may include one or more of the following: the amount of one-time and/or recurring payments required by the online platform, refund ratio, etc.

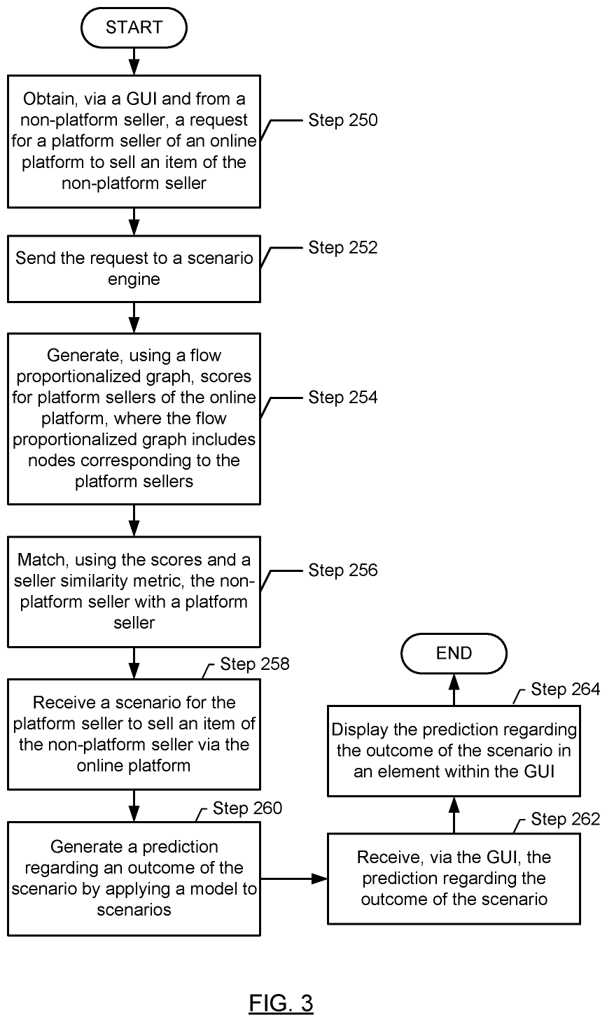

FIG. 3 shows a flowchart in accordance with one or more embodiments of the invention. The flowchart depicts a process for generating a recommendation. One or more of the steps in FIG. 3 may be performed by the components (e.g., the scenario engine (106) of the back-end computing system (104) and the management application (MA) (108) of the user computing system (102)), discussed above in reference to FIG. 1A. In one or more embodiments of the invention, one or more of the steps shown in FIG. 3 may be omitted, repeated, and/or performed in parallel, or in a different order than the order shown in FIG. 3. Accordingly, the scope of the invention should not be considered limited to the specific arrangement of steps shown in FIG. 3.

Initially, in Step 250, a request for a scenario for a platform seller of an online platform to sell an item of a non-platform seller is obtained via a graphical user interface (GUI). The request may be entered into the GUI by a user (e.g., the non-platform seller) of the management application.

In Step 252, the request is sent to the scenario engine. The request may be sent to the scenario engine by the management application over a network.

In Step 254, scores for platform sellers of the online platform are generated using a flow proportionalized graph (see description of Step 202 above).

In Step 256, the non-platform seller is matched with a platform seller using the scores and a seller similarity metric (see description of Step 204 above).

In Step 258, the scenario for the platform seller to sell an item of the non-platform seller via the online platform is received (see description of Step 206 above).

In Step 260, a prediction regarding an outcome of the scenario is generated by applying a model to scenarios (see description of Step 208 above).

In Step 262, the prediction regarding the outcome of the scenario is received by the GUI. In one or more embodiments, the prediction regarding the outcome of the scenario is sent, over the network, by the scenario engine to the management application.

In Step 264, the prediction regarding the outcome of the scenario is displayed via an element within the GUI (see description of Step 210 above).

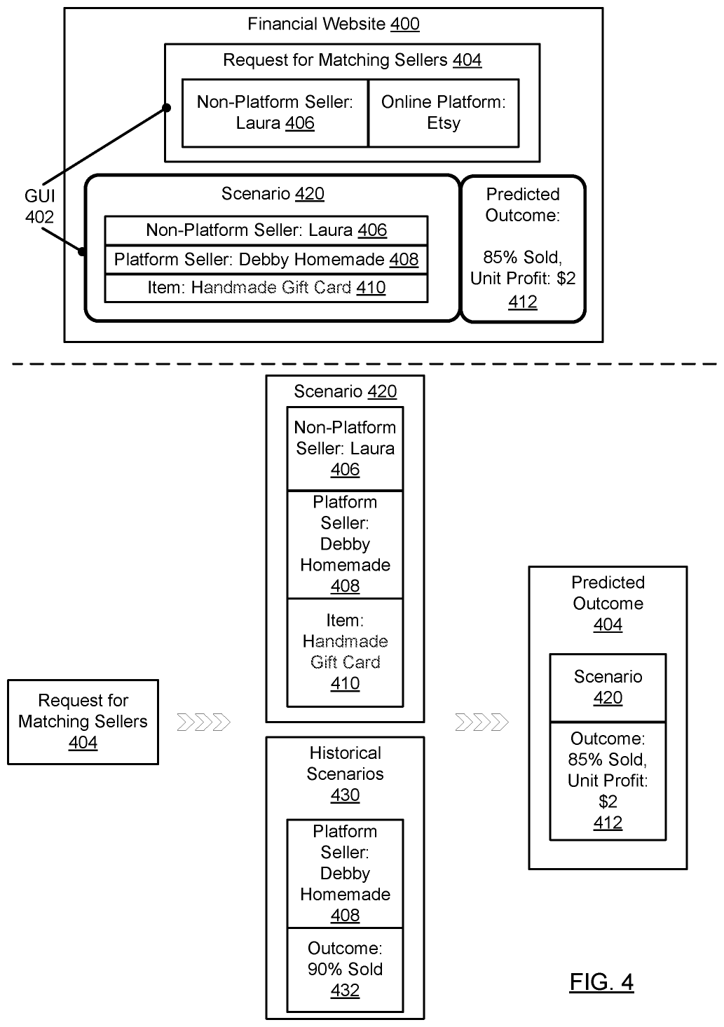

The following example is for explanatory purposes only and not intended to limit the scope of the invention. FIG. 4 shows an implementation example in accordance with one or more embodiments of the invention. FIG. 4 shows a financial website (400) executing a scenario engine. The scenario engine obtains a request for matching sellers (404) ((140) in FIG. 1A) entered by a non-platform seller Laura (406) ((132) in FIG. 1A) via a graphical user interface (GUI) (402) (e.g., a GUI of the management application (108) of FIG. 1A) of a user computing system that communicates with the financial website (400) over a network. The request for matching sellers (404) specifies the non-platform seller Laura (406) and an online platform, Etsy. That is, Laura is a non-platform seller relative to the Etsy online platform. Laura has a small business for selling handmade gift cards (410) ((126J) in FIG. 1A) for $10 each on Amazon. Laura is now considering expanding her business to the Etsy online platform. However, selling on Etsy requires building a website which may cost Laura hundreds of dollars and she would risk that, due to tough competition, Etsy buyers may not buy her cards at a sufficiently high price to offset her costs.

The scenario engine matches Laura with platform sellers on Etsy that sell items similar to handmade gift cards (410) relative to a similarity metric based on textual descriptions of invoices, stored in a data repository, corresponding to Laura and the platform sellers. The scenario engine, via the GUI (402), sends Laura a ranked list of similar platform sellers who also have scores exceeding a minimum threshold in a flow proportionalized graph derived from Etsy transactions accessible to the scenario engine. The GUI (402) permits Laura to examine various attributes corresponding to the list of similar platform sellers, such as inventory items, monthly sales volumes, Etsy on-boarding date, etc. Laura contacts the top-ranked platform seller Debby Homemade (408) after reading a short description of Debby Homemade (408) and visiting an Etsy page corresponding to Debby Homemade (408). The scenario engine receives from Laura, via the GUI (402), a scenario (420) ((130) in FIG. 1A) that includes the non-platform seller Laura (406), the platform seller Debby Homemade (408), and handmade gift cards (410).

The scenario engine generates a predicted outcome (412) ((144) in FIG. 1A) for the scenario (420) indicating 85% of the items sold, with a unit profit of $2. The scenario engine bases the predicted outcome (412) on the outcomes (432) corresponding to Debby Homemade (408) in historical scenarios (430) ((130E, 130K) in FIG. 1A) stored in the data repository. The scenario engine also bases the predicted outcome (412) on the volume of Etsy sales of items similar to handmade gift cards (410) using the Etsy transactions accessible to the scenario engine. The scenario engine, via the GUI (402), sends Laura the predicted outcome (412). Finding the predicted outcome (412) acceptable, Laura and Debby agree to a contract, thus activating the scenario (420). Debby Homemade (408) begins selling Laura's handmade gift cards (410). Laura has reduced her risk by avoiding the costs to setup a website on Etsy as well as avoiding other fees charged by Etsy. Debby also benefits by sharing in the profits due to the sales of the handmade gift cards (410) under the scenario (420).

Embodiments of the invention may be implemented on a computing system. Any combination of mobile, desktop, server, router, switch, embedded device, or other types of hardware may be used. For example, as shown in FIG. 5A, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

The computing system (500) in FIG. 5A may be connected to or be a part of a network. For example, as shown in FIG. 5B, the network (520) may include multiple nodes (e.g., node X (522), node Y (524)). Each node may correspond to a computing system, such as the computing system shown in FIG. 5A, or a group of nodes combined may correspond to the computing system shown in FIG. 5A. By way of an example, embodiments of the invention may be implemented on a node of a distributed system that is connected to other nodes. By way of another example, embodiments of the invention may be implemented on a distributed computing system having multiple nodes, where each portion of the invention may be located on a different node within the distributed computing system. Further, one or more elements of the aforementioned computing system (500) may be located at a remote location and connected to the other elements over a network.

Although not shown in FIG. 5B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5A. Further, the client device (526) may include and/or perform all or a portion of one or more embodiments of the invention.

The computing system or group of computing systems described in FIGS. 5A and 5B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the invention. The processes may be part of the same or different application and may execute on the same or different computing system.

Rather than or in addition to sharing data between processes, the computing system performing one or more embodiments of the invention may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the invention, may extract one or more data items from the obtained data. For example, the extraction may be performed as follows by the computing system in FIG. 5A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 5A, while performing one or more embodiments of the invention, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the invention, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 5A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 5A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 5A and the nodes and/or client device in FIG. 5B. Other functions may be performed using one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
generating, using a flow proportionalized graph, a plurality of scores for a plurality of platform sellers of an online platform, wherein the flow proportionalized graph comprises:
a plurality of nodes corresponding to the plurality of platform sellers and a plurality of buyers, and
a plurality of edges each connecting a buyer node corresponding to a buyer initiating a monetary transfer and a platform seller node corresponding to a platform seller receiving the monetary transfer,
wherein each edge has a weight that is a proportion of total monetary transfers by the buyer received by the platform seller, and
wherein each node of the plurality of nodes has a score based on scores of buyer nodes connected to the node by one of the plurality of edges;
matching, using the plurality of scores and a seller similarity metric, a non-platform seller with a platform seller of the plurality of platform sellers;
receiving a scenario for the platform seller to sell an item of the non-platform seller via the online platform; and
generating a prediction regarding an outcome of the scenario by applying a model to a first plurality of scenarios.

2. The method of claim 1, wherein using the seller similarity metric comprises:
obtaining a first textual description of an item of the non-platform seller and a second textual description of an item of the platform seller;
embedding the first textual description to obtain a first vector and the second textual description to obtain a second vector; and
determining that the first vector is within a threshold distance of the second vector.

3. The method of claim 1, wherein using the plurality of scores comprises:
determining that the score of the node corresponding to the platform seller exceeds a threshold score.

4. The method of claim 1, wherein the scenario comprises a plurality of attributes, the method further comprising:
displaying, in an element within a graphical user interface (GUI) generated by a computer processor, the prediction regarding the outcome of the scenario;
receiving, via the GUI and from the non-platform seller, a modification to an attribute of the plurality of attributes to obtain a modified scenario; and
generating a modified prediction by applying the model to the modified scenario.

5. The method of claim 1, wherein the first plurality of scenarios corresponds to the platform seller, and wherein the model is further applied to a volume of sales on the online platform of an item similar to the item of the scenario.

6. The method of claim 5, further comprising:
generating, using the first plurality of scenarios, a contract that specifies compensation of the non-platform seller and the platform seller.

7. The method of claim 1, wherein the model is trained using a second plurality of scenarios each labeled with a numerical attribute describing the outcome of the respective scenario.

8. A system, comprising:
a computer processor;
a repository configured to store a flow proportionalized graph comprising:
a plurality of nodes corresponding to a plurality of platform sellers and a plurality of buyers of an online platform, and
a plurality of edges each connecting a buyer node corresponding to a buyer initiating a monetary transfer and a platform seller node corresponding to a platform seller receiving the monetary transfer,
wherein each edge has a weight that is a proportion of total monetary transfers by the buyer received by the platform seller, and
wherein each node of the plurality of nodes has a score based on scores of buyer nodes connected to the node by one of the plurality of edges; and
a scenario engine, executing on the computer processor and configured to:
generate, using the flow proportionalized graph, a plurality of scores for the plurality of platform sellers,
match, using the plurality of scores and a seller similarity metric, a non-platform seller with a platform seller of the plurality of platform sellers,
receive a scenario for the platform seller to sell an item of the non-platform seller via the online platform, and
generate a prediction regarding an outcome of the scenario by applying a model to a first plurality of scenarios.

9. The system of claim 8, wherein the scenario engine is further configured to:
obtain a first textual description of an item of the non-platform seller and a second textual description of an item of the platform seller,
embed the first textual description to obtain a first vector and the second textual description to obtain a second vector, and
determine that the first vector is within a threshold distance of the second vector.

10. The system of claim 8, wherein using the plurality of scores comprises:
determining that the score of the node corresponding to the platform seller exceeds a threshold score.

11. The system of claim 8, wherein the system further comprises a graphical user interface (GUI), wherein the scenario comprises a plurality of attributes, and wherein the scenario engine is further configured to:
display, in the GUI, the prediction regarding the outcome of the scenario;
receive, via the GUI and from the non-platform seller, a modification to an attribute of the plurality of attributes to obtain a modified scenario; and
generate a modified prediction by applying the model to the modified scenario.

12. The system of claim 8, wherein the first plurality of scenarios corresponds to the platform seller, and wherein the model is further applied to a volume of sales on the online platform of an item similar to the item of the scenario.

13. The system of claim 12, the scenario engine is further configured to:
generate, using the first plurality of scenarios, a contract that specifies compensation of the non-platform seller and the platform seller.

14. The system of claim 8, wherein the model is trained using a second plurality of scenarios each labeled with a numerical attribute describing the outcome of the respective scenario.

15. A method comprising:
obtaining, via a graphical user interface (GUI) and from a non-platform seller, a request for a platform seller of a plurality of platform sellers of an online platform to sell an item of the non-platform seller;
sending the request to a scenario engine, wherein the scenario engine:
generates, using a flow proportionalized graph, the plurality of platform sellers, wherein the flow proportionalized graph comprises:
a plurality of nodes corresponding to the plurality of platform sellers and a plurality of buyers, and
a plurality of edges each connecting a buyer node corresponding to a buyer initiating a monetary transfer and a platform seller node corresponding to a platform seller receiving the monetary transfer,
wherein each edge has a weight that is a proportion of total monetary transfers by the buyer received by the platform seller, and
wherein each node of the plurality of nodes has a score based on scores of buyer nodes connected to the node by one of the plurality of edges;
matches, using the plurality of scores and a seller similarity metric, the non-platform seller with a platform seller of the plurality of platform sellers;
receives a scenario for the platform seller to sell an item of the non-platform seller via the online platform; and
generates a prediction regarding an outcome of the scenario by applying a model to a first plurality of scenarios;
receiving, via the GUI, the prediction regarding the outcome of the scenario; and
displaying, in an element within the GUI generated by a computer processor, the prediction regarding the outcome of the scenario.

16. The method of claim 15, wherein using the seller similarity metric comprises:
obtaining a first textual description of an item of the non-platform seller and a second textual description of an item of the platform seller;
embedding the first textual description to obtain a first vector and the second textual description to obtain a second vector; and
determining that the first vector is within a threshold distance of the second vector.

17. The method of claim 15, wherein using the plurality of scores comprises:
determining that the score of the node corresponding to the platform seller exceeds a threshold score.

18. The method of claim 15, wherein the scenario comprises a plurality of attributes, the method further comprising:
receiving, via the GUI and from the non-platform seller, a modification to an attribute of the plurality of attributes to obtain a modified scenario; and
generating a modified prediction by applying the model to the modified scenario.

19. The method of claim 15, wherein the first plurality of scenarios corresponds to the platform seller, and wherein the model is further applied to a volume of sales on the online platform of an item similar to the item of the scenario.

20. The method of claim 19, further comprising:
generating, using the first plurality of scenarios, a contract that specifies compensation of the non-platform seller and the platform seller.
